(19) United States
(12) Patent Application Publication
(10) Pub. No.: US 2025/0323749 A1
(43) Pub. Date: Oct. 16, 2025

(54) OPTICAL COMMUNICATIONS DEVICE AND TRANSMISSION CONTROL METHOD

(71) Applicant: Fujitsu Limited, Kawasaki-shi (JP)

(72) Inventors: Akio SUGAMA, Atsugi (JP); Shun OKADA, Kawasaki (JP)

(73) Assignee: Fujitsu Limited, Kawasaki-shi (JP)

(21) Appl. No.: 19/252,770

(22) Filed: Jun. 27, 2025

Related U.S. Application Data
(63) Continuation of application No. PCT/JP2023/045114, filed on Dec. 15, 2023.

(30) Foreign Application Priority Data
Jan. 20, 2023 (JP) 2023-007683

(51) Int. Cl. H04J 14/02

(52) U.S. Cl. CPC H04J 14/0212; H04J 14/0217

(57) ABSTRACT

A ROADM divides signal light among sub-ROADMs of multiple groups according to band. The sub-ROADMs have TPAs and WSSs constituting adding/dropping units for adding or dropping signal light in different bands with respect to desired routes, wavelength converters for converting wavelength bands of the signal light into a transmission band, and optical switches for switching and coupling the TPAs to transceivers. Further, the ROADM has a controller for controlling the TPAs of the adding/dropping units and the optical switches to add or drop signal light to be transmitted or received by the transceivers, the signal light being added to or dropped from desired routes, from the sub-ROADMs of the groups corresponding to the bands.

### CROSS REFERENCE TO RELATED APPLICATIONS

This is a continuation application of International Application PCT/JP2023/045114 filed on Dec. 15, 2023 which claims priority from a Japanese Patent Application No. 2023-007683 filed on Jan. 20, 2023, the contents of which are incorporated herein by reference.

### FIELD

Embodiments discussed herein are related to an optical communications device and a transmission control method.

### BACKGROUND

Broadband optical transmission is performed by multi-band, in which optical transmission wavelengths are grouped for each predetermined band (for example, band). Each node on a network is provided with a reconfigurable optical add/drop multiplexer (ROADM). A ROADM includes optical circuits (devices) such as an optical amplifier (AMP), a wavelength selective switch (WSS), a transponder aggregator (TPA), etc.

ROADMs are shifting from single-band to multi-band to accommodate higher bands. For example, up until now, only the C-band single-band optical circuits have been used, however, in recent years, despite transmission bands such as the S-band and the U-band being used to broaden bandwidth, the S-band and the U-band are wavelength converted to the C-band in the ROADM and route (degree) switching is performed in the C-band.

As a prior art, for example, there is a technology that accommodates twice the number of single-band signal processing devices as the number of single-band signal processing devices of a single joint box (registered trademark) in a cross-section of one joint box in a direction orthogonal to a signal cable. Further, there is a technology that by a wavelength selective switch provided in an optical transmission device, selectively outputs wavelength division multiplexed (WDM) light of an arbitrary wavelength to an output port. For examples, refer to International Publication No. WO 2017/145973 and Japanese Laid-Open Patent Publication No. 2006-140598.

### SUMMARY

According to an aspect of an embodiment, an optical communications device is coupled to a plurality of optical transmission paths of a plurality of routes (degrees), the optical communications device performing adding, dropping, or pass-through coupling of WDM signal light transmitted on the plurality of optical transmission paths, wherein the signal light is separated into a plurality of groups according to band. The optical communications device includes: a plurality of adding/dropping units each configured to add or drop the signal light with respect to a desired one of the plurality of routes according to the band, which differs for each of the plurality of groups; a plurality of wavelength converters each performing wavelength conversion of converting a wavelength band of the signal light into a transmission band; a plurality of optical switches configured to switch the plurality of adding/dropping units to any one of a plurality of transceivers for the signal light; and a controller configured to control the plurality of adding/dropping units and the plurality of optical switches so as to add or drop, with respect to the desired route of a group that among the plurality of groups corresponds to the band, the signal light that is to be transmitted or received by the any one of the plurality of transceivers.

An object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A is a diagram depicting an overview of an optical transmission control method.

FIG. 1B is another diagram depicting an overview of the optical transmission control method.

FIG. 2 is a diagram depicting an example of configuration of an optical transmission path network.

FIG. 3A is a diagram depicting an example of internal configuration of an existing single-band ROADM.

FIG. 3B is a diagram depicting an example of internal configuration of an existing multi-band ROADM.

FIG. 4A is a diagram depicting an example of internal configuration of a 16-route, 4-group (4-band) ROADM according to an embodiment.

FIG. 4B is another diagram depicting an example of internal configuration of the 16-route, 4-group (4-band) ROADM according to the embodiment.

FIG. 5 is a diagram depicting a control configuration example of a ROADM according to the embodiment.

FIG. 6 is a diagram depicting an example of hardware configuration of a controller of an optical transmission device.

FIG. 7 is a flowchart depicting an example of a control process of the ROADM according to the embodiment.

FIG. 8A is a diagram depicting an example of internal configuration of the ROADM in which four bands are divided into two groups.

FIG. 8B is another diagram depicting the example of internal configuration of the ROADM in which four bands are divided into two groups.

FIG. 9 is a diagram depicting an example of conversion of the ROADM.

### DESCRIPTION OF EMBODIMENTS

First, problems associated with the conventional techniques are discussed. It is desirable for the TPA provided in the ROADM to add/drop (insert/branch) signal light with respect to an arbitrary route. However, with multi-band, the number of TPA ports has to be increased and a problem arises in that this cannot be accommodated. For example, the TPA has to have network ports equivalent to the number of routes×the number of bands. For example, in an instance of 16 routes and 4 bands, 64 ports are necessary, however, no general-use TPA that meets this number of ports exists.

Embodiments of an optical communications device and a transmission control method according to the present disclosure are described in detail with reference to the accompanying drawings.

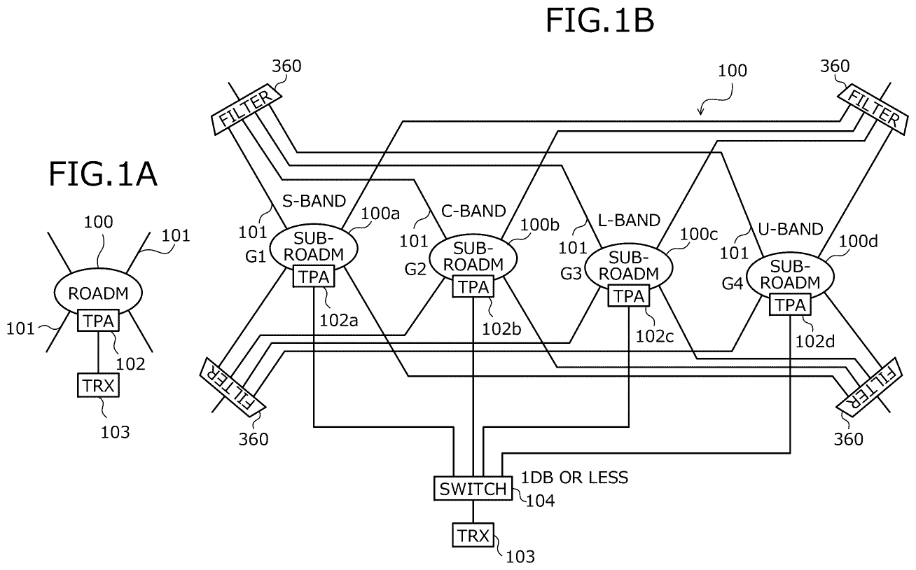

An overview of an optical transmission control method according to an embodiment is described. FIGS. 1A and 1B are diagrams depicting an overview of the optical transmission control method. FIG. 1A depicts a configuration example of an optical transmission device (ROADM) 100. A single ROADM 100 is coupled to optical transmission paths 101 of multiple routes. The optical transmission paths 101 transmit WDM light (signal light), which includes multiple wavelengths.

In the example depicted in FIG. 1A, the number of routes of the ROADM 100 is four and signal light of the optical transmission paths 101 of the routes has four different wavelength bands, for example, the S-band, the C-band, the L-band, and the U-band. The ROADM 100 passes and couples signal light of the optical transmission paths 101 between routes or the signal light is input/output (added/dropped) at the ROADM 100. Add/drop (insert/branch) means adding or dropping signal light.

A TPA 102 in the ROADM 100 couples (adds/drops) signal light input/output from a transceiver (TRX) 103, to the optical transmission path 101 of a desired one of the routes. The TPA 102 is a WSS, a multicast switch (MCS), or the like. In the description hereinafter, the adding/dropping of signal light with respect to the ROADM 100 is primarily described.

FIG. 1B depicts a specific example of an internal configuration of the ROADM 100 depicted in FIG. 1A. In the example depicted in FIG. 1B, the ROADM 100 groups optical transmission wavelengths of signal light according to predetermined wavelength bands (for example, bands) and creates four groups: G1, G2, G3, and G4. The TPA 102 is provided in plural, one for each group. Further, an optical switch (SW) 104 is provided between the TRX 103 and the multiple TPAs 102.

In the example depicted in FIG. 1B, the ROADM 100 has internally sub-ROADMs 100a, 100b, 100c, and 100d, respectively, for the four groups. Between each of the optical transmission paths 101 respectively of the four routes and the sub-ROADMs 100a to 100d, wavelength separating filters 360 are provided. The wavelength separating filters 360 separate the signal light of the optical transmission paths 101 into the S-band, the C-band, the L-band, and the U-band and outputs the separated signal light to the sub-ROADMs 100a to 100d.

The sub-ROADMs 100a to 100d have WSSs and TPAs 102a to 102d as adding/dropping units for the signal light. The optical switch 104 couples the signal light transmitted/received by the TRX 103 to any one of the TPAs 102a to 102d of the four sub-ROADMs 100a to 100d.

In the description described above, for example, the sub-ROADM 100a uses the wavelength separating filters 360 between the optical transmission paths 101 of the routes to add/drop the signal light of the S-band and at the sub-ROADM 100a, the S-band is wavelength-converted into the C-band. The sub-ROADM 100a adds/drops signal light with respect to the TPA 102a, in the C-band. As a result, general-use products for the C-band may be used for both the TPA 102a and the transponder (TRX) 103.

Further, the sub-ROADM 100b performs transmission of signal light of the C-band between the optical transmission paths 101 of the routes. The sub-ROADM 100c performs transmission of signal light of the L-band between the optical transmission paths 101 of the routes. The sub-ROADM 100d performs transmission of signal light of the U-band between the optical transmission paths 101 of the routes.

Further, in the sub-ROADMs 100b to 100d, the respective C-band, L-band, and U-band are each wavelength-converted into that of the C-band. As a result, general-use products for the C-band may be used for the TPA 102b to 102d and the transponder (TRX) 103.

A ROADM 100 on the transmission-side and a ROADM 100 on the reception-side perform optical transmission with respect to a single signal light or single band (for example, the S-band). In the example depicted in FIG. 1B, the optical switch 104 of the ROADM 100 on the transmission-side and the optical switch 104 of the ROADM 100 on the reception-side both operate by switching the signal light of the TRX 103, for example, to the sub-ROADM 100a of the S-band.

In the description above, for convenience, while a configuration is assumed in which the sub-ROADMs 100a to 100d are disposed for the bands S, C, L, and U, respectively, configuration is not limited to an arrangement for separating according to band and may be an arrangement for separating according to predetermined wavelength bands.

As for the ROADM of the embodiment, for example, by grouping one or two bands into a group and forming a closed sub-ROADM by the group, each resulting sub-ROADM may be of a same scale as that of an existing the C-band ROADM or C+L-band ROADM. Further, the TRX 103 is switched and coupled to the TPA of the sub-ROADM by the optical switch, whereby the sub-ROADM may be configured by existing equipment.

Further, access to all routes×bands by the TRX 103 becomes possible. The number of network ports of the TPA is a same as the number of routes and, for example, in an instance of 8 routes, there are 8 ports, and in an instance of 16 routes, there are 16 ports. Further, loss of the optical switch is small (for example, 1 dB or less) and the impact on budget is minimal.

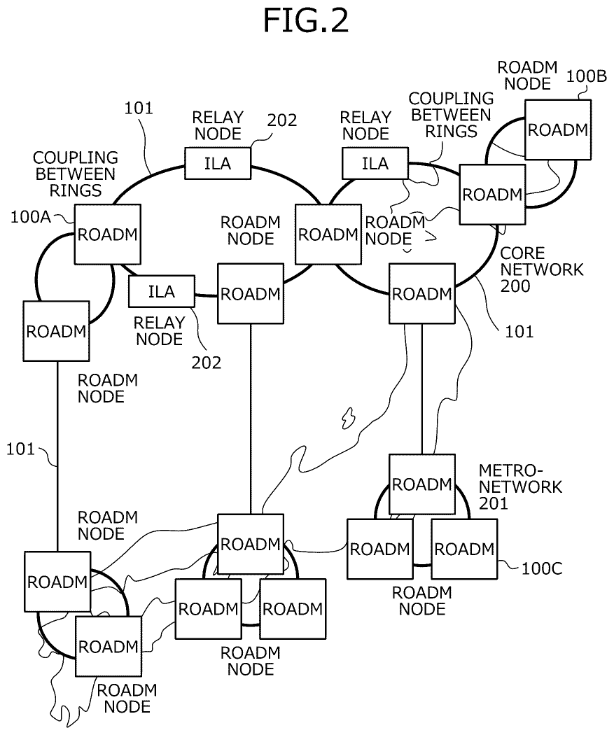

A problem associated with multi-band by an existing technique is discussed. FIG. 2 is a diagram depicting an example of configuration of an optical transmission path network. As depicted in FIG. 2, a core network 200 laid across the country using the optical transmission paths 101, and a metro-network 201 disposed in major cities and connected to the core network 200 have been built. The optical transmission paths 101 couple nodes of the core network 200 and nodes of the metropolitan network 201. Coupling of the nodes by the optical transmission paths 101 is a ring-type or a direct-type.

The optical transmission device (ROADM) 100 depicted in FIGS. 1A and 1B, for example, couples optical transmission paths 101 of two or more routes, such as an inter-ring coupling, among the nodes shown in FIG. 2. For example, the ROADM 100A has four routes. The ROADMs 100B, 100C have two routes. The number of routes is not limited to the number of routes herein and may be determined by geographical conditions of installation locations of the nodes and the amount of data handled by the nodes. Thus, in many instances four or more routes are necessary and, for example, 16 routes may be demanded. Further, relay nodes 202 do not have a function of adding/dropping (TPA and TRX) signal light and have a relay function such as optically amplifying signal light of a coupled pair of the optical transmission paths 101.

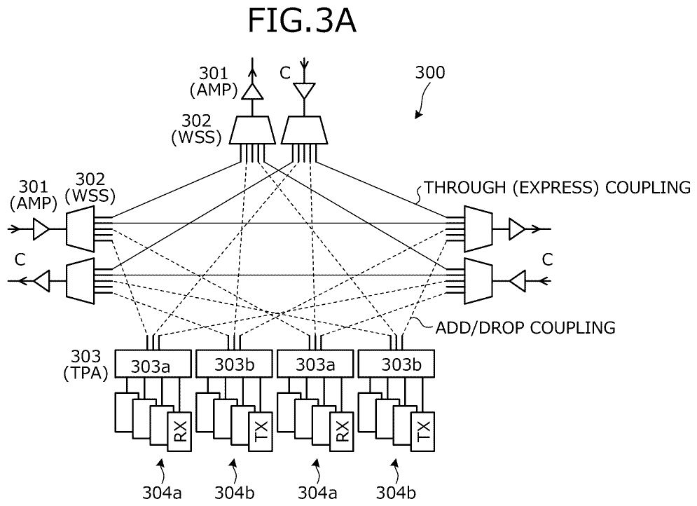

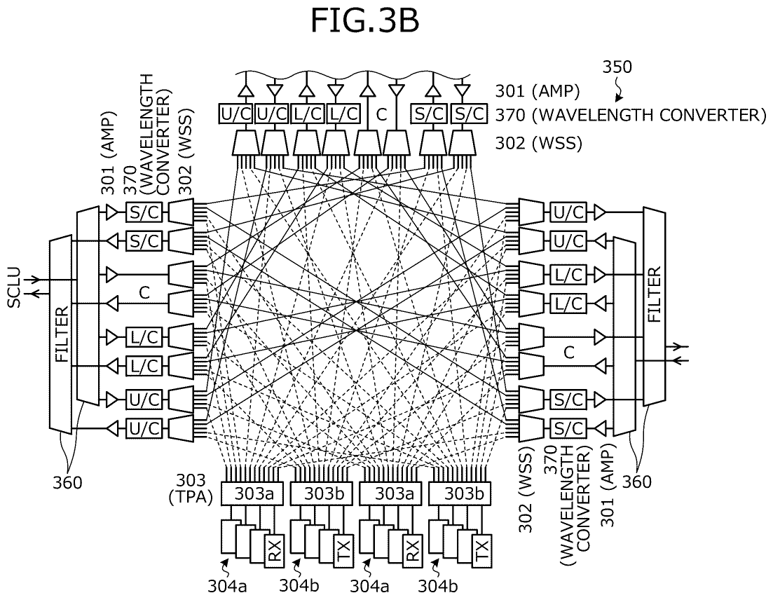

FIG. 3A is a diagram depicting an example of internal configuration of an existing single-band ROADM. A ROADM 300 depicted in FIG. 3A is an example of a 3-route configuration, and the optical transmission paths 101 optically transmit signal light by the C-band wavelength band. In the ROADM 300, optical amplifiers (AMPs) 301 and WSSs 302 are each provided at input-sides and output-sides of each of the routes.

In the single-band ROADM 300, optical coupling paths by optical fibers include pass-through (express, solid lines in drawing) and add/drop (dashed lines in drawing) paths, and the signal light of each is the C-band. In the example depicted in FIG. 3A, four disposed TPAs 303 each have three ports that respectively correspond to three routes; two TPAs 303a are connected to eight receivers (RX) 304a and two TPAs 303b are connected to eight transmitters (TX) 304b.

FIG. 3B is a diagram depicting an example of internal configuration of an existing multi-band ROADM. FIG. 3B depicts an example of configuration of a multi-band ROADM 350 assuming an instance of three routes and four bands (S, C, L, U) similar to FIG. 3A, and components similar to those in FIG. 3A are given the same reference numerals used in FIG. 3A.

Assuming the configuration depicted in FIG. 3A, an instance in which the number of bands is simply increased to four is conceivable. In this instance, for example, as depicted in FIG. 3B, for each route, the wavelength separating filters 360 and wavelength converters 370 for converting signal light of each of the bands S, L, U into the C-band (the C-band is transparent) are additionally disposed for the input and output of the signal light. Two of the wavelength separating filters 360, for example, are used after two bands are separated to further separate two bands.

In FIG. 3B as well, in the multi-band ROADM 350, optical coupling paths by optical fibers include pass-through (express, solid lines in drawing) and add/drop (dashed lines in drawing) paths, and the signal light of each is the C-band.

Here, from the perspective of colorless, directionless and contentionless (CDC), access to an arbitrary route and band by the transponder (TRX) 304 is desirable. However, due to multi-band, the number of network ports of the TPAs 303 increases.

In an instance of the configuration depicted in FIG. 3B, as for the number of network ports of the TPAs 303, the number of routes (3)×the number of bands=12 ports are necessary. Here, in an instance in which the number of routes is 8, 32 ports are necessary and in an instance in which the number of routes is 16, 64 ports are necessary. Currently, the TPAs 303 are only available with up to 16 ports, which limits the number of routes or bands that can be used in multi-band configurations.

In contrast, according to the embodiment, as described with reference to FIGS. 1A and 1B, by grouping one or two bands into a group and forming a closed sub-ROADM by the group, each resulting sub-ROADM may be of a same scale as that of an existing the C-band ROADM or a C+L-band ROADM. Further, the transponder (TRX) is switched and coupled to the TPA of the sub-ROADM by the optical switch, whereby the sub-ROADM may be configured by existing equipment, and the transponder (TRX) becomes capable of accessing all the routes×the bands.

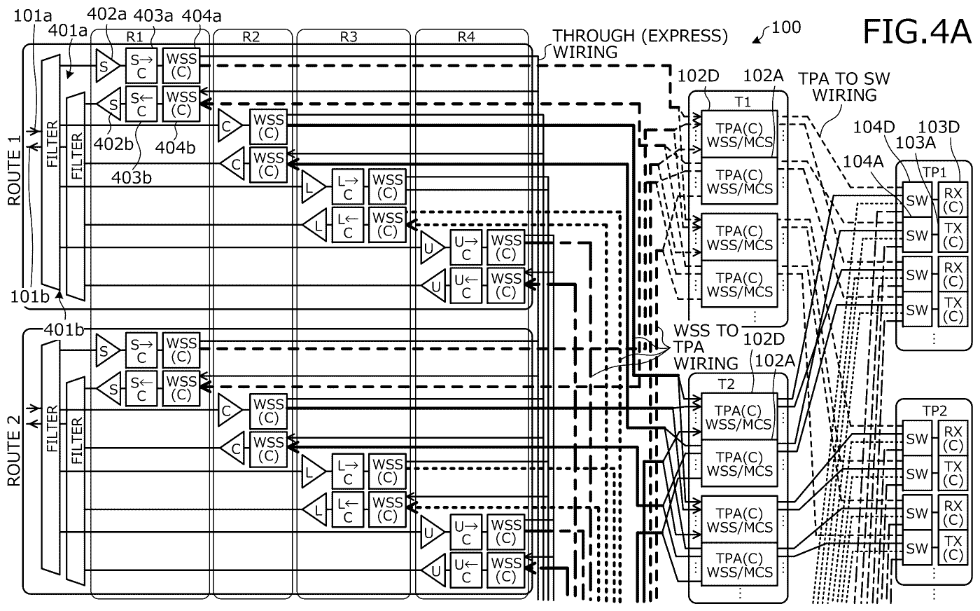

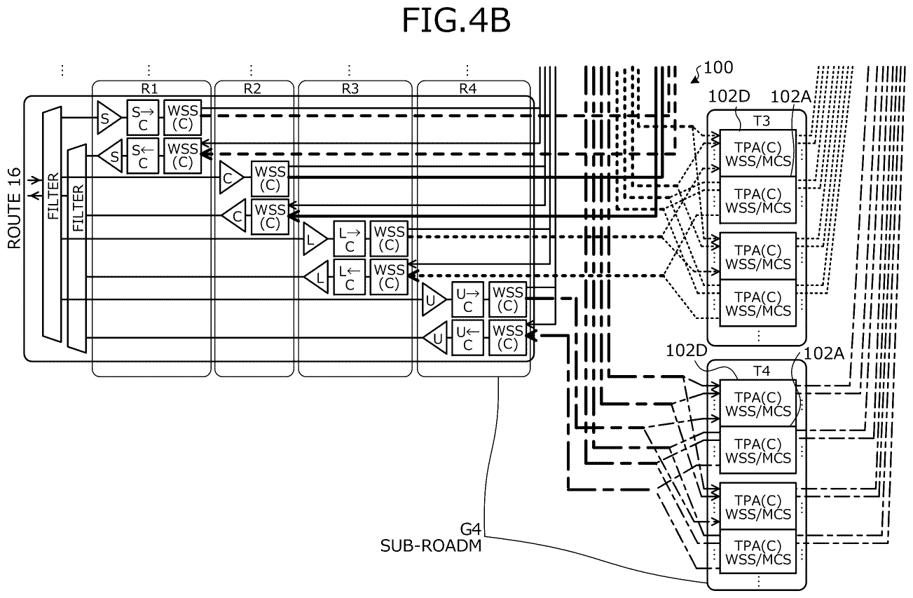

An example of internal configuration of a 3-route, 4-band ROADM is described. FIGS. 4A and 4B are diagrams depicting an example of internal configuration of a 16-route, 4-group (4-band) ROADM according to the embodiment. The four groups correspond to the configuration example of the sub-ROADMs 100a to 100d depicted in FIGS. 1A and 1B. Group 1 (G1) is formed by an S-band portion R1 in the routes and a TPA group T1 to which the S-band portion R1 is connected. Similarly, group 2 is formed by a portion R2 and a TPA group T2, group 3 is formed by a portion R3 and a TPA group T3, group 4 is formed by a portion R4 and a TPA group T4. The transmission paths in FIGS. 4A and 4B are depicted with different line types for groups 1 to 4. In the multi-band ROADM 100, optical coupling paths by optical fibers include pass-through (express) and add/drop, and the signal light of each of the C-band.

Coupling configuration of an input-side (drop) of route 1 is described as an example; signal light of an optical transmission path 101a on the input-side is separated into four bands (S, C, L, U) by a filter 401a. The filter 401a separates the signal light into four bands by combining a bandpass filter, a lowpass filter, and a highpass filter, etc.

The optical amplifier 402a for each of the bands (S, C, L, U) is coupled to the output of the four bands of the filter 401a. The wavelength converter 403a for wavelength-converting the signal light of each of the (S, L, U) is coupled downstream of the optical amplifier 402a. The wavelength converter 403a suffices to be prepared for the three bands (S, L, U) for which wavelength conversion is necessary and a wavelength converter for the C-band is unnecessary.

Converters having a nonlinear effect of, for example, general-use periodically poled lithium niobate (PPLN) may be used as the wavelength converter 403a. The PPLN wavelength converter 403a, using difference frequency generation (DFG) with respect to the signal light and pump light, outputs converted light.

A WSS 404a on the input-side is coupled downstream of the wavelength converter 403a. The wavelength band of the WSS 404a is the C-band. Two pass-through optical coupling paths of the WSS 404a are coupled to a WSS 404b on the output-sides of route 2 to route 16. Add/drop optical coupling paths of the WSS 404a are coupled to a TPA 102D (D: Drop) for input (dropping), among the TPAs 102 of a TPA group that corresponds to the group to which the WSS belongs. The TPA 102D is a WSS or a multicast switch (MCS), etc.

FIGS. 4A and 4B depict groups TP of the TRXs 103 and the optical switches 104 with 4×1 ports provided in the ROADM 100. Downstream of a TPA 102D, receivers (RX 103D) are coupled to a group TP1 via a switch (SW) 104D for input. The TPA 102D has 19 network ports, which is equivalent in number to the number of routes. The network ports of the TPA 102D are respectively coupled to the WSSs 404 on the input-side of the routes.

Further, four network-side ports of the SW 104D of the group TP1 are respectively coupled to the TPA 102D of the TPA groups T1 to T4.

Among client-side ports of the TPA 102D, one client-side port is coupled to one receiver 103D via the optical switch 104D. The optical switch 104D switches between four input ports and outputs to one output port.

Among client-side ports of the TPA 102D, the remaining ports are respectively coupled to different receivers (RXs) 103D . . . , via different optical switches 104 . . . In the TPA 102D, the number of network ports, the number of routes M, the number of client-side ports suffices to be equivalent to the number of transponder connections N (in the example depicted in FIG. 4A, M=16 and N≥2 is assumed and many commercial products are about 16).

Optical coupling paths of signal light branch-input (dropped) in the ROADM 100 depicted in FIGS. 4A and 4B are described. For example, an optical coupling path of route 1 from an input of the signal light to group 1 (the S-band input) to the receiver 103D is from the optical transmission path 101a to the filter 401a to the optical amplifier 402a to the wavelength converter 403a to the WSS 404a to the TPA 102D to the optical switch 104D to RX 103D.

Further, an optical coupling path of signal light that is to be insertion-output (added) from the ROADM 100 is described. For example, an optical coupling path from one of the transmitters (103A) to group 1 (the S-band output) of route 1 is from the TX 103A (A: add) to the optical switch 104A to the TPA 102A to the WSS 404b to the wavelength converter 403b to the optical amplifier 402b to a filter 401b to the optical transmission path 101b.

Further, the input/output coupling configurations from other routes 2 to 16 are similar to that for route 1.

Here, the TPA group T1, which includes a pair of TPA 102D and TPA 102A, is used for group 1 for S-band input/output of routes 1 to 16. Similarly, the remaining TPA groups T2, T3, and T4, each including a pair of the TPAs 102, belong to group 2 for C-band input/output of routes 1 to 16, group 3 for L-band input and output of route 1 to 16, and group 4 for U-band input/output of routes 1 to 16, respectively.

Further, signal light of the respectively groups: group 1 (the S-band), group 2 (the C-band), group 3 (the L-band), and group 4 (the U-band) is input to the four ports of a pair of the optical switches 104a, 104b, respectively. Similarly, for the remaining three sets of the optical switches 104, which are pairs of the optical switches 104, the signal light of the S, C, L, and U bands is input/output.

According to the configuration depicted in FIGS. 4A and 4B, by switching the optical switch 104 (104D, 104A) having 4 inputs and 1 output, communication is performed by connecting only one of the four groups included in the optical transmission paths 101 (101a, 101b) to the TRX 103 (RX 103D, TX 103A).

Further, in the configuration depicted in FIGS. 4A and 4B in which an optical path is arbitrarily selected in the ROADM 100 of 16 routes and four groups, on the input-side (drop), four each of the TPAs 102, the 4×1 (four-port) optical switches 104, and receivers 103 suffice to be provided. Similarly, on the output-side (add), transmitters 103, the 1×4 (four-port) optical switches 104, and the TPAs 102 each suffice to be provided.

Here, for both the TPA 102a and the TPA 102b, a device having a general-use number of ports (in the present embodiment, 16) may be used on the network-side. According to the embodiment, even when the number of routes and the number of bands increase, the ROADM 100 may be configured using the TPA 102, which has a small general-use number of ports.

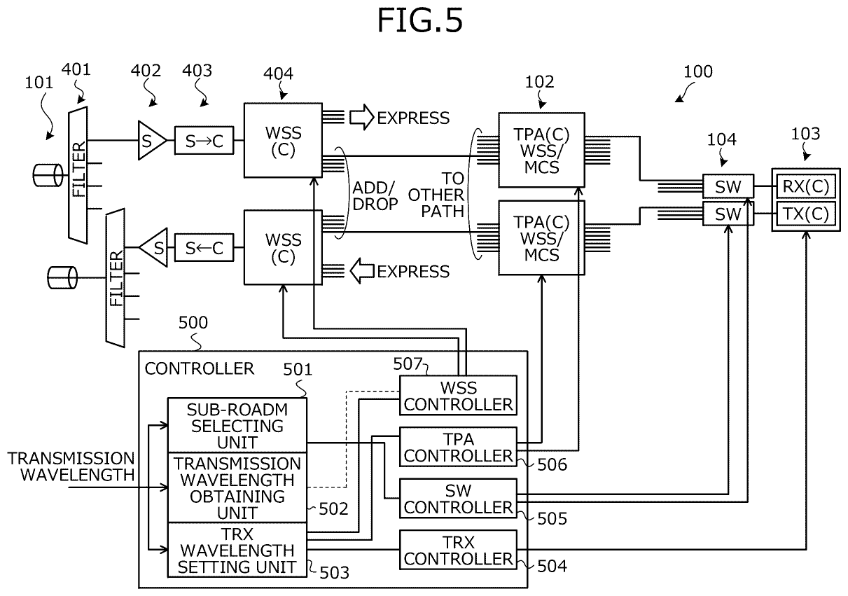

FIG. 5 is a diagram depicting a control configuration example of the ROADM according to the embodiment. With reference to FIG. 5, an internal configuration of a controller 500 of the ROADM 100 is mainly described while other aspects of the internal configuration of the ROADM 100 (refer to FIGS. 4A and 4B, etc.) are not described.

The controller 500 of the ROADM 100 includes a sub-ROADM selecting unit 501, a transmission wavelength obtaining unit 502, a TRX wavelength setting unit 503, a TRX controller 504, a switch (SW) controller 505, a TPA controller 506, and a WSS controller 507.

Transmission wavelength information is input to the ROADM 100. For example, for each adding/dropping of signal light, transmission wavelength information for the signal light is input and output between relevant stations. For example, the transmission wavelength information includes information regarding the band (S, C, L, U) of the signal light. The transmission wavelength obtaining unit 502 obtains information regarding the transmission wavelength (band) of signal light to be transmitted on the optical transmission paths 101.

For example, the ROADM 100 of a certain station at location A and the ROADM 100 of another station at location B are assumed to be coupled. In this instance, a management system (not depicted) that manages wavelength resources selects the wavelength of the signal light in the ROADM 100 between A and B, taking into consideration the usage state of the wavelengths of all routes. The respective ROADMs 100 (the transmission wavelength obtaining units 502) of the certain station and the other station obtain the transmission wavelength of the signal light selected by the management system.

According to the signal light transmission wavelength (band) obtained by the transmission wavelength obtaining unit 502, the sub-ROADM selecting unit 501 determines to which sub-ROADM (in FIGS. 1A and 1B, 100a to 100d) the signal light belongs. Based on the sub-ROADM selection, the optical coupling paths described in FIGS. 4A and 4B for the signal light of each band are formed.

The TRX wavelength setting unit 503 sets the transponder (transmitting/receiving) wavelength of the transceivers (TRXs) 103 according to whether wavelength conversion is used for the respective bands (S, C, L, U) of the signal light. For example, in an instance in which wavelength conversion of the signal light is not used (the C-band is used as is), the TRX wavelength setting unit 503 sets the transmission wavelength (the C-band) as the transponder wavelength. On the other hand, in an instance in which wavelength conversion is used (S, L, U), the TRX wavelength setting unit 503 determines the original wavelength (wavelength before wavelength conversion) and sets the determined wavelength as the transponder wavelength.

The TRX controller 504 instructs the corresponding transceiver (TRX) 103 to set the transponder wavelength set by the TRX wavelength setting unit 503.

The switch controller 505 switches to the desired sub-ROADM for the adding or dropping performed by the optical switch 104 that is coupled to the transceiver (TRX) 103. This sub-ROADM switching corresponds to the selection of a pair of the TPAs 102 according to the groups (bands) depicted in FIGS. 4A and 4B.

The TPA controller 506 controls the TPA 102 coupled to the optical switch 104 to switch to the desired route based on the band set by the TRX wavelength setting unit 503. In an instance in which the TPA is a WSS, in addition to this path setting, the wavelength is set so that the TRX wavelength is passed. The WSS controller 507 sets the path and the wavelength so that the port to which the TPA leading to the desired transceiver (TRX) 103 is coupled passes the TRX wavelength.

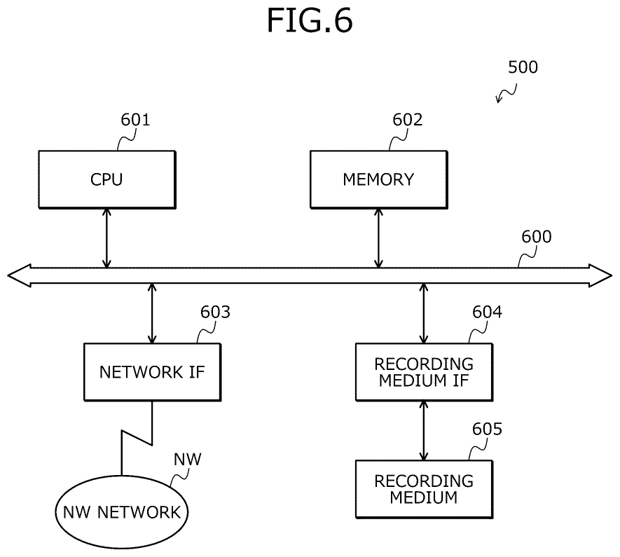

FIG. 6 is a diagram depicting an example of hardware configuration of the controller of the optical transmission device. The controller 500 of the ROADM 100 depicted in FIG. 5, for example, may be configured by the hardware depicted in FIG. 6.

For example, the controller 500 has a processor 601 such as a central processing unit (CPU), a memory 602, a network IF 603, a recording medium IF 604, and a recording medium 605. Further, the components are coupled to each other via a bus 60.

Here, the processor 601 is a control unit for governing overall control of the controller 500. The processor 601 may have multiple cores. The memory 602, for example, includes a read-only memory (ROM), a random-access memory (RAM), and a flash ROM, etc. More specifically, for example, the flash ROM stores therein control programs, the ROM stores therein application programs, and the RAM is used as a work area of the processor 601. Programs stored in the memory 602 are loaded onto the processor 601, whereby encoded processes are executed by the processor 601.

The network IF 603 administers an internal interface with a network NW and controls the input and output of information with respect to the management system, which manages other ROADMs 100 and wavelength resources.

The recording medium IF 604, under the control of the processor 601, controls the reading and writing of data with respect to the recording medium 605. The recording medium 605 stores data written thereto under the control of the recording medium IF 604.

In addition to the components above, the controller 500, for example, may be coupled to an input device, a tablet, a display, etc. via an IF.

The processor 601 depicted in FIG. 6 may execute functions of the controller 500 depicted in FIG. 5, by executing a program.

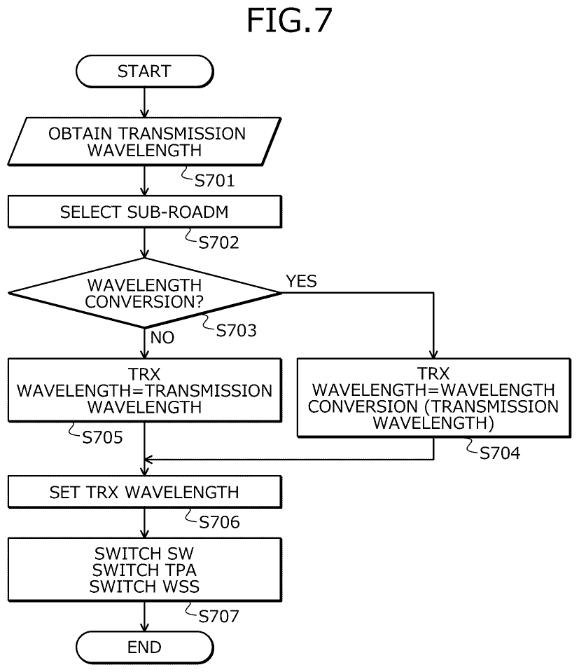

FIG. 7 is a flowchart depicting an example of a control process of the ROADM according to the embodiment. An example of a control process performed by the controller 500 (the CPU 601 in FIG. 6) in FIG. 5 executing a program is described.

First, the controller 500 obtains, from the management system, etc., the transmission wavelength to be used for signal light that is to be added to or dropped from the optical transmission paths 101 (step S701). Next, the controller 500 selects one of the sub-ROADMs 100a to 100d, which are band-specific (refer to FIGS. 1A and 1B) (step S702). Here, it is determined to which wavelength (band) and group the obtained signal light wavelength belongs.

Next, the controller 500 determines whether to convert the wavelength of the signal light (step S703). In an instance in which the wavelength of signal light is to be converted (step S703: YES), the controller 500 determines the original wavelength (wavelength before wavelength conversion) and sets the determined wavelength as the transponder wavelength (TRX) (step S704). On the other hand, in an instance in which the wavelength of the signal light is not to be converted (step S703: NO), the controller 500 sets the transmission wavelength as the transponder wavelength (step S705).

Next, the controller 500 sets the transponder wavelength set at step S704 or step S705 in the transceiver (TRX) 103 (step S706).

Thereafter, the controller 500 controls the switching of the optical switch 104, the TPA 102, and the WSSs 404 (step S707). The controller 500 switches the optical switch 104 coupled to the transceiver (TRX) 103 to a desired sub-ROADM (corresponds to the TPA 102), switches the TPA 102 to a desired route, and adds/drops signal light with respect to the WDM signal light using the WSSs 404. The order in which the switching of optical switch 104, the TPA 102, and the WSSs 404 is performed is interchangeable.

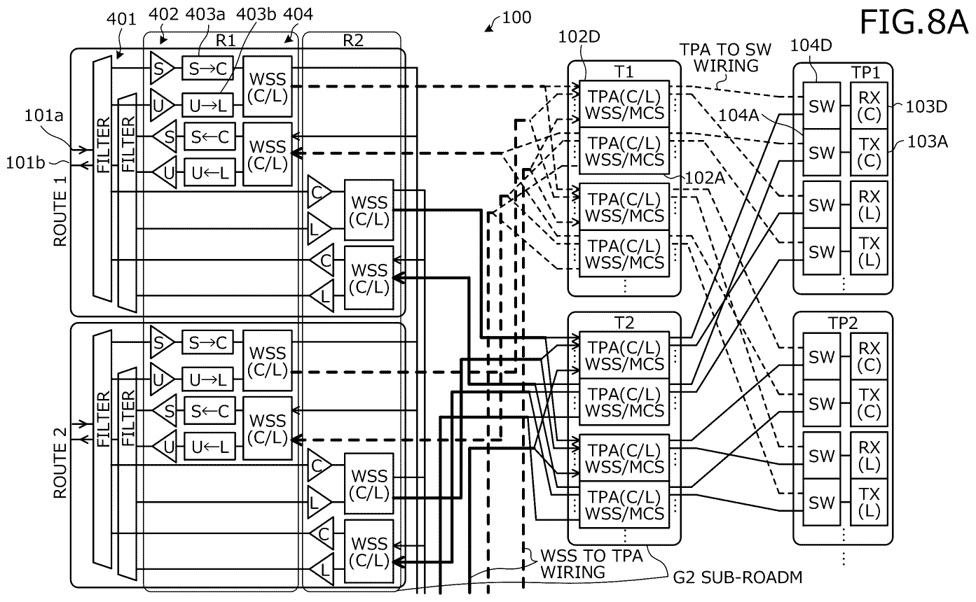

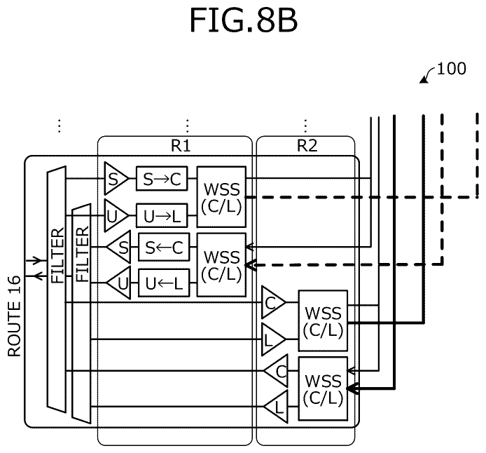

FIGS. 8A and 8B are diagrams depicting an example of internal configuration of the ROADM in which four bands are divided into two groups. Four-band, two-group is a configuration example in which the S-band and the U-band constitute one group (G1) while the C band and the L-band constitute one group (G2). In FIGS. 1A and 1B, the two groups G1 and G2 correspond to the two sub-ROADMs 100a and 100b.

The TPA 102a uses the ones corresponding to the C-band and the L-band. In this instance, in group G1, the wavelength converter 403a that converts the S-band to the C-band and the wavelength converter 403b that converts the U-band to the L-band are provided. The WSSs 404 and the TPAs 102 (102D, 102A) perform optical switching for the C+L-band.

Further, in group G2, the C-band and the L-band are coupled to the WSSs 404 and the wavelength converter 403 is not provided. The WSSs 404 and the TPAs 102 perform optical switching of the C+L-band.

The transceivers (TRXs) 103 (103D, 103A) include a transceiver 103C for the C-band and a transceiver 103L for the L-band. In an instance of the configuration example in FIGS. 8A and 8B, the ROADM 100 may be configured by the optical switches 104 (104D, 104A), the transceiver 103C for the C-band, and the transceiver 103L for the L-band. As for the transceivers 103, while commercial products are available for the C-band and for the L-band, no products are available for the S-band or the U-band.

As described, in the configuration example of the ROADM 100 depicted in FIGS. 8A and 8B, the optical switch 104 having n×1 (2×1) ports may be used, the number of groups may be reduced, and the simple optical switch 104 with a small number of ports may be used.

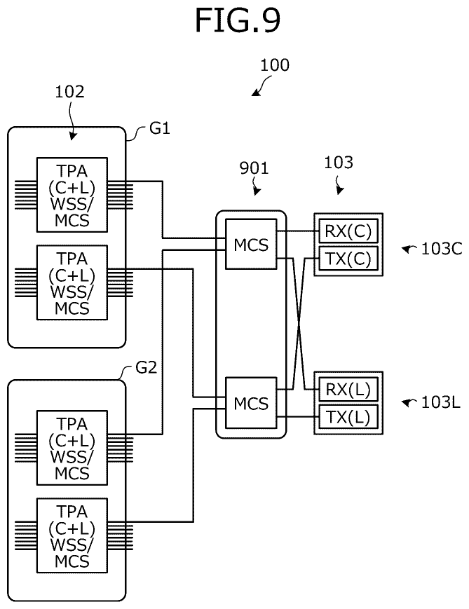

FIG. 9 is a diagram depicting an example of conversion of the ROADM. In FIG. 9, the details of the groups G1, G2 depicted in FIGS. 8A and 8B are not depicted and only the TPA 102 is depicted. As depicted in FIG. 9, between the TPA 102 and the transceiver (TRX) 103, instead of the optical switch 104 depicted in FIG. 8A, a MCS 901 may be disposed. The MCS 901 has n×m (2×2) ports.

In terms of the configuration on the input-side, the MCS 901 couples n (2 ports) on one side to the TPAs 102 of group G1 and group G2, and m (2 ports) on the other side to the C-band receiver (RX) 103C and the L-band receiver (RX) 103L. In terms of the configuration on the output-side, the MCS 901 couples n (2 ports) on one side to the TPA 102 in group G1 and group G2, and m (2 ports) on the other side to the C-band transmitter (TX) 103C and the L-band transmitter (TX) 103L.

According to the configuration example depicted in FIG. 9, a pair of the transceivers 103C for the C-band is coupled to the TPA 102 of the group G1 or the group G2 by the switching of the switch by the MCS 901. Similarly, a pair of the transceivers 103L for the L-band is coupled to the TPA 102 of the group G1 or the group G2.

As a result, in the configuration example of the ROADM 100 depicted in FIG. 9, each of the pairs of the optical switches 104 depicted in FIGS. 8A and 8B may be replaced with one MCS 901, enabling the number of components to be reduced, and connection wiring may be simplified as compared to that in FIGS. 8A and 8B.

For example, an instance is considered in which a 16-route×16-port TPA is configured in a 16-route, 4-band ROADM. In an instance in which configuration is by combining WSSs or MCSs using the existing technology, 112 units of a 1×32-port WSS are necessary, which is an unrealistic number of WSSs. In contrast, according to the ROADM 100 of the embodiment, a single 4×1-port optical switch 104 is provided, thereby enabling configuration by merely disposing four of the 16×16-port MCSs 901 and enabling realization of reduced costs and simplification of the internal configuration.

In the embodiment described above, while an example in which sub-bands grouped by band S, C, L, U is described, grouping is not limited to bands and the transmission wavelengths may be grouped according to a predetermined band, for example, 4.8 THz. In this instance, the number of the ROADMs 100 provided suffices to be a same number as the number of sub-bands that correspond to the number of divisions.

The optical communications device of the embodiment described above is coupled to optical transmission paths of multiple routes and performs adding/dropping or pass-through coupling of WDM signal light transmitted on the optical transmission paths. The optical communications device separates the signal light into multiple groups according to band. The multiple groups each have adding/dropping units that add or drop signal light with respect to a desired route of a different band for each group, a wavelength converter that converts the wavelength of the signal light to that of a transmission band, and an optical switch that switches and couples the multiple adding/dropping units to a transceiver of the signal light. The optical communications device has a controller that controls the adding/dropping units and the optical switches to couple and add to or drop from desired routes of the group corresponding to the band, the signal light to be transmitted or received by the transceivers.

More specifically, the optical communications device may have a wavelength filter that separates signal light input from an optical transmission path, into a first signal band and a second signal band; a first wavelength converter that converts the second signal band into a third signal band; a first adding/dropping unit that adds or drops the first signal band with respect to a desired route; a second adding/dropping unit that adds or drops the third signal band with respect to a desired route; and the first optical switch that enables selection of whether to guide the signal light from any one of the first adding/dropping unit and the second adding/dropping unit to an optical receiver. The optical communications device may further have a second optical switch that enables selection of whether to guide light from an optical transmitter of any one of the first adding/dropping unit and the second adding/dropping unit; a second wavelength converter that converts the third signal band into the second signal band; and a wavelength filter that combines and outputs to optical transmission paths, the first signal band and the second signal band. Further, the third signal band may be the same as the first signal band.

As described, by configuring a closed sub-ROADM in a group, it becomes possible to add/drop a large number of routes and optical signals of a large number of bands, with a simple configuration. As a result, multi-band, which widens the band of the optical transmission wavelength, is promoted and arbitrary route switching becomes possible.

Further, the optical communications device may be configured to include multiple wavelength selective switches having adding/dropping units corresponding to the routes and transponder aggregators (TPAs) that couple signal light transmitted/received by the transceivers to the wavelength selective switch of a desired route. As a result, it becomes possible to add/drop a large number of routes and optical signals of a large number of bands, using a general-use TPA having a small number of ports.

Further, in the optical communications device, as for the transponder aggregator, the number of network ports is the number of routes M and the number of client-side ports is the number of transceiver couplings N. For example, in an instance of 16 routes×16 devices, a configuration for M and N may use the general-use 16 ports.

Further, for the optical communications device, the groups may be constituted by four groups including the S-band, the C-band, the L-band, and the U-band, which are bandwidth-specific. In this instance, the wavelength converters convert the wavelength of each band to that of the C-band; and the wavelength selective switches, the transponder aggregators, and the transceivers use the C-band. Further, each of the optical switches may have 4×1 ports, i.e., four ports on the transponder-aggregator-side and one port on the transceiver-side. As a result, adding/dropping of signal light for a four-band WDM signal may be performed by a simple configuration.

Further, in the optical communications device, the controller may obtain transmission wavelength information for the signal light transmitted between the station thereof and a counterpart station; and may determine the group of the signal light based on the obtained transmission wavelength information. As a result, the multiple groups may add or drop, with respect to desired routes, signal light of respectively different bands.

Further, in the optical communications device, based on the obtained transmission wavelength information, the controller may determine whether wavelength conversion in the group of the signal light is performed and may control whether the wavelength converter performs wavelength conversion. As a result, for example, in the group in which the transmission wavelength is the C-band, wavelength conversion is unnecessary and an internal configuration using the general-use C-band may be used. In the other groups in which the respective transmission wavelengths are the S-band, the C-band, the L-band, and the U-band, an internal configuration using the general-use C-band may be used and by wavelength conversion, signal light to be added/dropped may be set to a suitable transmission wavelength.

Further, for the optical communications device, the groups may be constituted by two groups including one constituted by the S-band and the U-band, and another constituted by the C-band and the L-band, which are bandwidth-specific. In this instance, the wavelength converters convert the respective bandwidths of the S-band and the U-band to that of the C-band; the wavelength selective switches and the transponder aggregators have bandwidths for the C-band and the L-band; and the transceivers have one for the C-band and one for the L-band. Further, each of the optical switches may have 2×1 ports, i.e., two ports on the transponder-aggregator-side and one port on the transceiver-side. As a result, an internal configuration such as a general-purpose C+L band TPA can accommodate four bands of transmission wavelengths, and an optical switch with a small number of ports may be used.

Further, the optical communications device has multicast switches (MCSs) instead of the optical switches and each of the multicast switches may be configured to have 2×2 ports, i.e., two ports on the transponder-aggregator-side and two ports on the transceiver-side. As described, the MCSs are used, whereby the number of optical switches is reduced thereby enabling a simple configuration.

The following Notes are further disclosed regarding the embodiments above.

Note 1: An optical communications device coupled to a plurality of optical transmission paths of a plurality of routes, the optical communications device performing adding, dropping, or pass-through coupling of WDM signal light transmitted on the plurality of optical transmission paths, wherein the signal light is separated into a plurality of groups according to band, the optical communications device including: a plurality of adding/dropping units each configured to add or drop the signal light with respect to a desired one of the plurality of routes according to the band, which differs for each of the plurality of groups; a plurality of wavelength converters each performing wavelength conversion of converting a wavelength band of the signal light into a transmission band; a plurality of optical switches configured to switch the plurality of adding/dropping units to a plurality of transceivers of the signal light; and a controller configured to control the plurality of adding/dropping units and the plurality of optical switches so as to add or drop, with respect to the desired route of a group that among the plurality of groups corresponds to the band, the signal light that is to be transmitted or received by the plurality of transceivers.

Note 2: The optical communications device according to Note 1, wherein the plurality of adding/dropping units has: a plurality of wavelength selective switches corresponding to the plurality of routes, and a plurality of transponder aggregators coupling the signal light that is to be transmitted or received by the plurality of transceivers, to one of the plurality of wavelength selective switches, said one being of the desired route.

Note 3: The optical communications device according to Note 2, wherein in each of the plurality of the transponder aggregators, a number of network ports is a number M of the plurality of routes and a number of client-side ports is a number N of the plurality of transceivers.

Note 4: The optical communications device according to Note 2, wherein the plurality of groups is constituted by four groups including: an S-band, a C-band, an L-band, a U-band, which are bandwidth-specific; the plurality of wavelength converters convert a bandwidth of each band into the C-band; the plurality of wavelength selective switches, the plurality of transponder aggregators, and the plurality of transceivers use the C-band; and each of the plurality of optical switches has 4×1 ports including four ports for coupling to the transponder aggregator and one port for coupling to the transceiver.

Note 5: The optical communications device according to Note 1, wherein the controller: obtains transmission wavelength information concerning the signal light that is transmitted between a station of the optical communications device and a counterpart station, and determines the group of the signal light based on the obtained transmission wavelength information.

Note 6: The optical communications device according to Note 5, wherein the controller determines based on the obtained transmission wavelength information, whether the wavelength conversion is to be performed in the group of the signal light and controls whether the wavelength conversion is performed by controlling the plurality of wavelength converters.

Note 7: The optical communications device according to Note 2, wherein the plurality of groups includes two bandwidth-specific groups including, respectively, an S-band and a U-band, and a C-band and an L-band; the plurality of wavelength converters convert a wavelength band of the S-band and a wavelength band of the U-band to a wavelength band of the C-band; the plurality of wavelength selective switches and the plurality of transponder aggregators support the wavelength band of the C-band and a wavelength band of the L-band; the plurality of transceivers support the C-band and the L-band; and the plurality of optical switches have 2×1 ports including two ports for coupling to the plurality of transponder aggregators and one port for coupling to the plurality of transceivers.

Note 8: The optical communications device according to Note 7, wherein instead of the plurality of optical switches, a multicast switch is provided, the multicast switch having 2×2 ports including two ports for coupling to the plurality of transponder aggregators and two ports for coupling to the plurality of transceivers.

Note 9: An optical communications device coupled to a plurality of optical transmission paths of a plurality of routes, the optical communications device performing adding, dropping, or pass-through coupling of WDM signal light transmitted on the plurality of optical transmission paths, the optical communications device including: a first wavelength filter that separates the signal light input from one of the plurality of optical transmission paths, into a first signal band and a second signal band; a first wavelength converter that converts the second signal band into a third signal band; a first adding/dropping unit that adds or drops the first signal band with respect to a desired one of the plurality of routes; a second adding/dropping unit that adds or drops the third signal band with respect to a desired one of the plurality of routes; and a first optical switch selectively guiding the signal light from any one of the first adding/dropping unit and the second adding/dropping unit to an optical receiver.

Note 10: The optical communications device according to Note 9, further comprising: a second optical switch selectively guiding the signal light from an optical transmitter to any one of the first adding/dropping unit and the second adding/dropping unit; a second wavelength converter that converts the third signal band into the second signal band; and a wavelength filter that combines and outputs to any one of the plurality of optical transmission paths, the first signal band and the second signal band.

Note 11: The optical communications device according to Note 9 or 10, wherein the third signal band is a same as the first signal band.

Note 12: A transmission control method for adding, dropping, or pass-through coupling WDM signal light transmitted on a plurality of optical transmission paths of a plurality of routes, the signal light being coupled to any one of the plurality of optical transmission paths, the method comprising: separating the signal light into a plurality of groups according to band; adding or dropping the signal light the with respect to a desired one of the plurality of routes according to the band, which differs for each of the plurality of groups; converting a wavelength band of the signal light into a transmission band; and performing switching for the signal light that is to be added or dropped and coupling the signal light to a transceiver.

Note 13: The transmission control method according to Note 12, the method further comprising: obtaining transmission wavelength information concerning the signal light that is transmitted between a station of the optical communications device and a counterpart station; and determining the group of the signal light based on the obtained transmission wavelength information.

According to one aspect of the present disclosure, multi-band, which widens the band of the optical transmission wavelength, is promoted and arbitrary route switching using a general-use TPA becomes possible.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical communications device coupled to a plurality of optical transmission paths of a plurality of routes (degrees), the optical communications device performing adding, dropping, or pass-through coupling of WDM signal light transmitted on the plurality of optical transmission paths, wherein
the signal light is separated into a plurality of groups according to band, the optical communications device comprising:
a plurality of adding/dropping units each configured to add or drop the signal light with respect to a desired one of the plurality of routes according to the band, which differs for each of the plurality of groups;
a plurality of wavelength converters each performing wavelength conversion of converting a wavelength band of the signal light into a transmission band;
a plurality of optical switches configured to switch the plurality of adding/dropping units to any one of a plurality of transceivers for the signal light; and
a controller configured to control the plurality of adding/dropping units and the plurality of optical switches so as to add or drop, with respect to the desired route of a group that among the plurality of groups corresponds to the band, the signal light that is to be transmitted or received by the any one of the plurality of transceivers.

2. The optical communications device according to claim 1, wherein
the plurality of adding/dropping units has:
a plurality of wavelength selective switches corresponding to the plurality of routes, and
a plurality of transponder aggregators coupling the signal light that is to be transmitted or received by the any one of the plurality of transceivers, to one of the plurality of wavelength selective switches, the one wavelength selective switch being of the desired route.

3. The optical communications device according to claim 2, wherein
in each of the plurality of the transponder aggregators, a required number of network ports is a number M of the plurality of routes and a required number of client-side ports is a number N of the plurality of transceivers.

4. The optical communications device according to claim 2, wherein
the plurality of groups is constituted by four groups including: an S-band, a C-band, an L-band, a U-band, which are bandwidth-specific,
the plurality of wavelength converters convert a bandwidth of each band into the C-band,
the plurality of wavelength selective switches, the plurality of transponder aggregators, and the plurality of transceivers use the C-band, and
each of the plurality of optical switches has 4×1 ports including four ports for coupling to the transponder aggregator and one port for coupling to the any one of the plurality of transceivers.

5. The optical communications device according to claim 1, wherein the controller:
obtains transmission wavelength information concerning the signal light that is transmitted between a station of the optical communications device and a counterpart station, and
determines the group of the signal light, based on the obtained transmission wavelength information.

6. The optical communications device according to claim 5, wherein
the controller determines based on the obtained transmission wavelength information, whether the wavelength conversion is to be performed in the group of the signal light and controls whether the wavelength conversion is performed by controlling the plurality of wavelength converters.

7. The optical communications device according to claim 2, wherein
the plurality of groups includes two bandwidth-specific groups including, respectively, an S-band and a U-band, and a C-band and an L-band,
the plurality of wavelength converters convert a wavelength band of the S-band to a wavelength band of the C-band and a wavelength band of the U-band to a wavelength band of the L-band,
the plurality of wavelength selective switches and the plurality of transponder aggregators support the wavelength band of the C-band and a wavelength band of the L-band,
the plurality of transceivers support the C-band and the L-band, and
the plurality of optical switches have 2×1 ports including two ports for coupling to the plurality of transponder aggregators and one port for coupling to the any one of the plurality of transceivers.

8. The optical communications device according to claim 7, wherein instead of the plurality of optical switches, a multicast switch is provided, the multicast switch having 2×2 ports including two ports for coupling to the plurality of transponder aggregators and two ports for coupling to the plurality of transceivers.

9. An optical communications device coupled to a plurality of optical transmission paths of a plurality of routes (degrees), the optical communications device performing adding, dropping, or pass-through coupling of WDM signal light transmitted on the plurality of optical transmission paths, the optical communications device including:
a first wavelength filter that separates the signal light input from one of the plurality of optical transmission paths, into a first signal band and a second signal band;
a first wavelength converter that converts the second signal band into a third signal band;
a first adding/dropping unit that adds or drops the first signal band with respect to a desired one of the plurality of routes;
a second adding/dropping unit that adds or drops the third signal band with respect to a desired one of the plurality of routes; and
a first optical switch selectively guiding the signal light from any one of the first adding/dropping unit and the second adding/dropping unit to an optical receiver.

10. The optical communications device according to claim 9, further comprising:
a second optical switch selectively guiding the signal light from an optical transmitter to any one of the first adding/dropping unit and the second adding/dropping unit;
a second wavelength converter that converts the third signal band into the second signal band; and
a wavelength filter that combines and outputs to any one of the plurality of optical transmission paths, the first signal band and the second signal band.

11. The optical communications device according to claim 9, wherein the third signal band is a same as the first signal band.

12. A transmission control method for adding, dropping, or pass-through coupling WDM signal light transmitted on a plurality of optical transmission paths of a plurality of routes (degrees), the signal light being coupled to any one of the plurality of optical transmission paths, the method being executed by a processor, the method comprising:
separating the signal light into a plurality of groups according to band;
adding or dropping the signal light with respect to a desired one of the plurality of routes according to the band, which differs for each of the plurality of groups;
converting a wavelength band of the signal light into a transmission band; and
performing switching for the signal light that is to be added or dropped and coupling the signal light to a transceiver.

13. The transmission control method according to claim 12, the method further comprising:
obtaining transmission wavelength information concerning the signal light that is transmitted between a station of the optical communications device and a counterpart station; and
determining the group of the signal light, based on the obtained transmission wavelength information.

14. The transmission control method according to claim 13, further comprising:
determining, based on the obtained transmission wavelength information, whether wavelength conversion in the group of the signal light is performed; and
controlling whether a wavelength converter performs the wavelength conversion.
